(19) United States
(12) Patent Application Publication
(10) Pub. No.: US 2019/0346876 A1
(43) Pub. Date: Nov. 14, 2019

(54) SHARING A SERIAL BUS INTERFACE AMONG DEVICES HAVING DIFFERENT OPERATING SPEEDS

(71) Applicant: QUALCOMM Incorporated, San Diego, CA (US)

(72) Inventors: ZhenQi CHEN, South Boston, MA (US); Scott DAVENPORT, Merrimack, NH (US); Helena Deirdre O'SHEA, San Diego, CA (US); Lalan Jee MISHRA, San Diego, CA (US); Wolfgang ROETHIG, Campbell, CA (US)

(21) Appl. No.: 15/976,782

(22) Filed: May 10, 2018

(51) Int. Cl. G06F 1/08; G06F 13/42

(52) U.S. Cl. CPC G06F 1/08; G06F 13/4282

(57) ABSTRACT

Systems, methods, and apparatus for sharing a serial bus interface among devices having different operating speeds are described. A sequence of commands on a data line of the serial bus are generated including a start condition signal and a device identifier signal where the identifier signal is part of a command frame in the sequence of commands. The sequence of commands is transmitted on the data line concurrent with the transmission of a clock signal on a clock line of the serial bus during the duration of the device identifier signal. The frequency of the clock signal is set at a first clock frequency for the duration of the device identifier signal where the first clock frequency is a frequency supported among all devices coupled to the serial bus, allowing all devices to decode an initial sequence, whether the devices are configured for higher frequency operation or not.

### TECHNICAL FIELD

The present disclosure relates generally to sharing a bus among devices having different operating speeds and, more particularly, to sharing a serial bus interface among disparate slave devices respectively using different clock line operating frequencies where a clock frequency of the clock line is initially set at a lower frequency.

### INTRODUCTION

Mobile communication devices may include a variety of components including circuit boards, integrated circuit (IC) devices and/or System-on-Chip (SoC) devices. The components may include processing circuits, user interface components, storage, RF modems and circuity, and other peripheral components that may communicate through serial buses. Such serial buses may operate in accordance with a standardized or proprietary protocol, such as I2C or I3C, as examples.

In one particular example, a bus or interface protocol has been developed by the Mobile Industry Processor Interface (MIPI) alliance for control of radio frequency (RF) slave devices or components in mobile communication devices. This protocol, termed the MIPI RF Front-End Interface (i.e., MIPI RFFE℠), is a dedicated control interface for the RF front end of a mobile device, which typically has higher performance requirements and can include 10 or more devices or components such as transmitting power amplifiers, receiving low noise amplifiers (LNAs), antenna tuners, filters, and switches. The RFFE interface can be applied to the full range of RF front-end components to simplify product design, configuration and integration, and to facilitate interoperability of components.

In certain aspects, the MIPI RFFE V1.0 standard defined the bus clock frequency to be up to 26 MHz, whereas the MIPI RFFE V2.0/V2.1 standard defined the bus clock frequency to be up to 52 MHz. Further, a newly proposed clock frequency for the MIPI RFFE V3.0 standard will be up to 78 MHz. Legacy MIPI RFFE V1.0/V2.0/V2.1 compliant devices cannot accept any new command sequence at the 78 MHz clock. In order to deal with this frequency disparity, existing solutions include separating the devices onto respective, separate MIPI RFFE buses operating at different clock frequencies. Thus, for example, a bus running at 78 MHz can only connect to new 78 MHz devices, whereas the bus running at 52 MHz only connect to the legacy 52 MHz devices. Therefore, extra MIPI RFFE busses are needed to support mixed frequency devices in a system. Accordingly, there is a need to be able to connect slower and faster devices on a same, shared RFFE bus interface.

### SUMMARY

Certain aspects of the disclosure relate to systems, apparatus, methods, and techniques that afford sharing of a serial bus among a plurality of devices coupled to the bus and having different operating frequencies.

According to an aspect, a method is disclosed for sharing a serial bus among a plurality of devices having differing operating frequencies that are coupled to the serial bus. The method includes generating a sequence of commands on a first line of the serial bus, the sequence of commands including at least a start condition signal and a device identifier signal where the device identifier signal is part of a command frame in the sequence of commands. The method further includes transmitting the sequence of commands on the first line of the serial bus and concurrently transmitting a clock signal on a second line of the serial bus during at least the duration of the device identifier signal, wherein the frequency of the clock signal is set at a first clock frequency for at least the duration of the device identifier signal, wherein the first clock frequency is a frequency that is supported among all of the plurality of devices coupled to the serial bus.

According to another aspect, an apparatus is disclosed that includes a bus interface configured to couple the apparatus to a serial bus having a first line configured to carry data and command signals and a second line configured to carry a clock signal. The apparatus further includes at least one processing circuitry configured to generate a sequence of commands on the first line of the serial bus, where the sequence of commands includes at least a start condition signal and a device identifier signal, where the device identifier signal is part of a command frame in the sequence of commands. The at least one processing circuity is further configured to transmit the sequence of commands on the first line of the serial bus and concurrently transmit a clock signal on the second line of the serial bus during at least the duration of the device identifier signal, wherein the frequency of the clock signal is set by the at least one processing circuitry at a first clock frequency for at least the duration of the device identifier signal, wherein the first clock frequency is a frequency that is supported among all of a plurality of devices coupled to the serial bus where at least two of the plurality of devices have different operating frequencies.

According to yet another aspect, an apparatus is disclosed that is coupled to a serial bus shared among a plurality of devices having differing operating frequencies coupled to the serial bus. The apparatus includes means for generating a sequence of commands on a first line of the serial bus, the sequence of commands including at least a start condition signal and a device identifier signal, wherein the device identifier signal is part of a command frame in the sequence of commands. Additionally, the apparatus includes means for transmitting the sequence of commands on the first line of the serial bus and concurrently transmitting a clock signal on a second line of the serial bus during at least the duration of the device identifier signal, wherein the frequency of the clock signal is set at a first clock frequency for at least the duration of the device identifier signal, wherein the first clock frequency is a frequency that is supported among all of the plurality of devices coupled to the serial bus.

In yet a further aspect, a non-transitory computer-readable medium storing computer-executable code is disclosed. The code is configured to cause a computer to generate a sequence of commands on a first line of a serial bus, the sequence of commands including at least a start condition signal and a device identifier signal, wherein the device identifier signal is part of a command frame in the sequence of commands. Furthermore, transmit the sequence of commands on the first line of the serial bus coupled to a plurality of devices having at least two different operating frequencies, and concurrently transmit a clock signal on a second line of the serial bus during at least the duration of the device identifier signal, wherein the frequency of the clock signal is set at a first clock frequency for at least the duration of the device identifier signal, wherein the first clock frequency is a frequency that is supported among all of the plurality of devices coupled to the serial bus.

### BRIEF DESCRIPTION OF THE DRAWINGS

FIG. 1 illustrates an apparatus that includes a RF front end (RFFE) system that may be adapted according to certain aspects disclosed herein.

FIG. 2 is a block diagram illustrating an RFFE bus or interface system to couple various front end devices.

FIG. 3 illustrates an example of a system architecture for an apparatus employing a data link between master and slave devices using an RFFE bus or interface according to certain aspects disclosed herein.

FIG. 4 illustrates another example of a system architecture for an apparatus employing a data link between master and slave devices using an RFFE bus or interface according to certain aspects disclosed herein.

FIG. 5 illustrates a timing diagram that illustrates an example of signaling on a serial bus for an RFFE command sequence in accordance with certain aspects disclosed herein.

FIG. 6 is a flowchart illustrating certain aspects of a methodology disclosed herein for serial bus communication.

FIG. 7 is a block diagram illustrating an example of an apparatus employing a processing circuit that may be adapted according to certain aspects disclosed herein.

FIG. 8 illustrates a hardware implementation for an apparatus adapted to perform on-chip clock generator calibration in accordance with certain aspects disclosed herein.

FIG. 9 is a flowchart illustrating certain other aspects of the disclosed methods herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the present methods and apparatus will now be presented in the following detailed description and illustrated in the accompanying drawings by various blocks, modules, components, circuits, steps, processes, algorithms, etc. (collectively referred to as “elements”). These elements may be implemented using electronic hardware, computer software, firmware, or any combination thereof. Whether such elements are implemented as hardware, software, or firmware depends upon the particular application and design constraints imposed on the overall system.

Exemplary Apparatus with Multiple IC Device Subcomponents

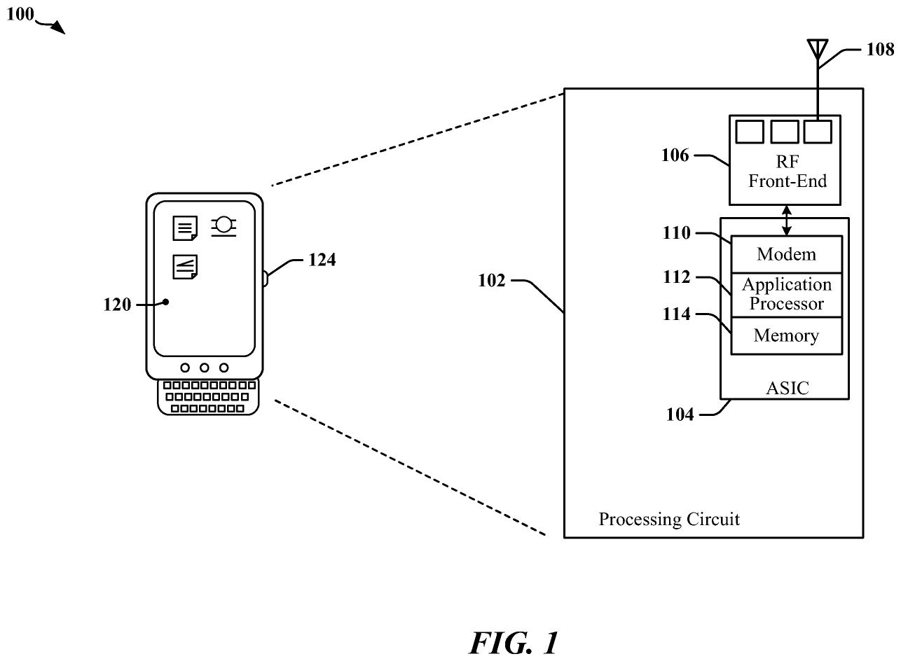

Certain aspects of the presently disclosed methods and apparatus may be applicable to communications links deployed between electronic devices that include subcomponents of an apparatus such as a telephone, a mobile computing device, an appliance, automobile electronics, avionics systems, etc. FIG. 1 depicts an apparatus 100 that may employ a communication link between IC devices. In one example, the apparatus 100 may be a mobile communication device. The apparatus 100 may include a processing circuit 102 having two or more IC devices 104, 106 that may be coupled using a first communication link One IC device may be an RF front end device 106 that enables the apparatus to communicate through one or more antennas 108 with a radio access network (RAN), a core access network, the Internet and/or another network. The RF front end device 106 may include a plurality of devices coupled by a second communication link, which may include an RFFE bus.

In a further aspect, the processing circuit 102 may include one or more application-specific IC (ASIC) devices, such as IC device 104. In one example, device 104 may be an ASIC device 104 including (as illustrated) or coupled with one or more processing devices 112, logic circuits, one or more modems 110, and processor readable storage such as a memory device 114 that may maintain instructions and data executable by a processor on the processing circuit 102. The processing circuit 102 may be controlled by one or more of an operating system and an application programming interface (API) layer that supports and enables execution of software modules residing in storage media. The memory device 114 may include read-only memory (ROM) or random-access memory (RAM), electrically erasable programmable ROM (EEPROM), flash cards, or any memory device that can be used in processing systems and computing platforms. The processing circuit 102 may include or have access to a local database or parameter storage that can maintain operational parameters and other information used to configure and operate apparatus 100. The local database may be implemented using one or more of a database module, flash memory, magnetic media, EEPROM, optical media, tape, soft or hard disk, or the like. The processing circuit may also be operably coupled to external devices such as the antennas 108, a display 120, operator controls, such as a button 124 and/or an integrated or external keypad 122, among other components.

### Overview of the RFFE Bus

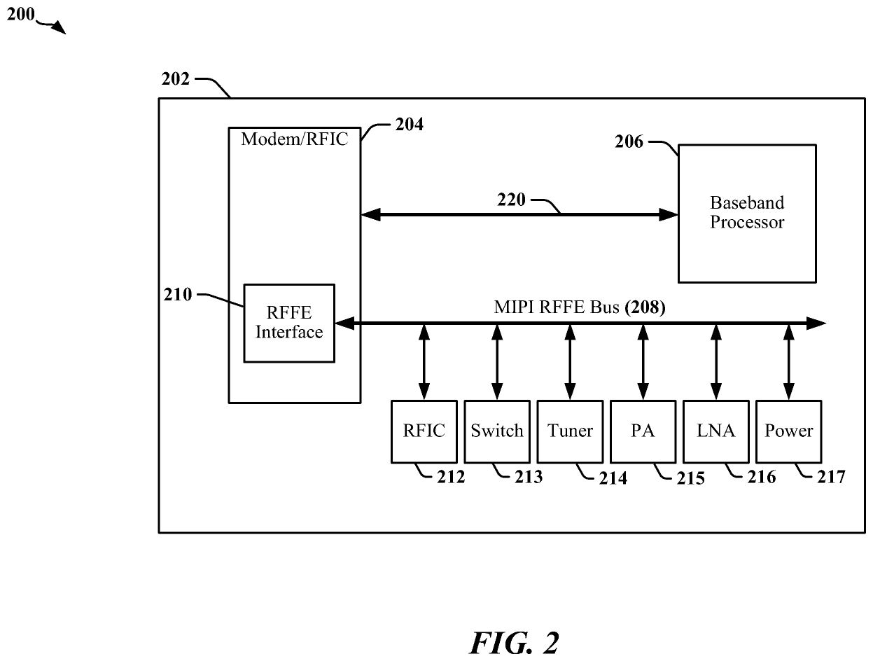

FIG. 2 is a block diagram 200 illustrating an example of a system 202 that employs an RFFE bus 208 to couple various front end devices 212-217. A modem 204 including an RFFE interface 210 may also be coupled to the RFFE bus 208. In various examples, the device 202 may be implemented with one or more baseband processors 206, one or more other communication links 220, and various other buses, devices and/or different functionalities. In the example, the modem 204 may communicate with a baseband processor 206, and the device 202 may be embodied in one or more of a mobile computing device, a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, avionics systems, a wearable computing device (e.g., a smart watch, a health or fitness tracker, eyewear, etc.), an appliance, a sensor, a security device, a vending machine, a smart meter, a drone, or any other similar functioning device.

The RFFE bus 208 may be coupled to an RF integrated circuit (RFIC) 212, which may include one or more controllers and/or processors that configure and control certain aspects of the RF front end. The RFFE bus 208 may couple the RFIC 212 to a switch 213, an RF tuner 214, a power amplifier (PA) 215, a low noise amplifier (LNA) 216, and a power management module 217.

In an example, the baseband processor 206 may be a master device. The master device/baseband processor 206 may drive the RFFE bus 208 to control the various front end devices 212-217. During transmission, the baseband processor 206 may control the RFFE interface 210 to select the power amplifier 215 for a corresponding transmission band. In addition, the baseband processor 206 may control the switch 213 so that the resulting transmission may propagate from an appropriate antenna. During reception, the baseband processor 206 may control the RFFE interface 210 to receive from the low noise amplifier 216 depending on the corresponding transmission band. It should be appreciated that numerous other components may be controlled through the RFFE bus 208 in this fashion such that the device 202 is merely representative and not limiting. Moreover, other devices such as the RFIC 212 may serve as an RFFE master device in other embodiments.

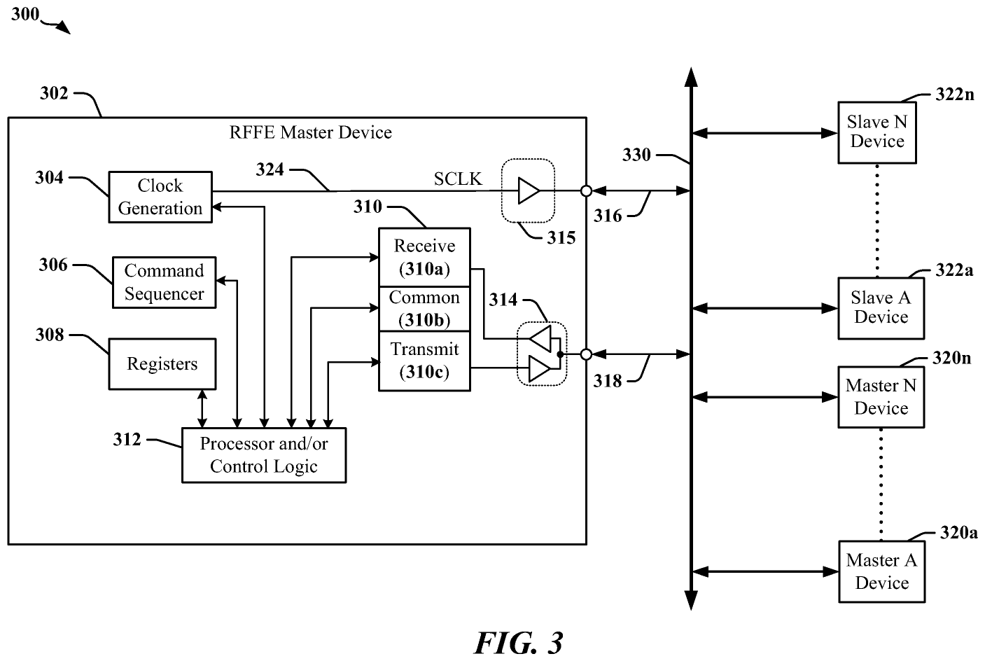

FIG. 3 is a block schematic diagram illustrating an example of an architecture for a device 300 that may employ an RFFE bus 330 to communicatively couple bus master devices 320a-320n and slave devices 302 and 322a-322n. The RFFE bus 330 may be configured according to application needs, and access to multiple buses 330 may be provided to certain of the devices 320a-320n, 302, and 322a-322n. In operation, one of the bus master devices 302 from of a plurality of master devices 320a-320n may gain control of the bus 330 and transmit an identifier for a slave device such as a unique slave identifier (USID) that is akin to a slave address, to identify one of the slave devices 322a-322n to engage in a communication transaction. Bus master devices 302 and 320a-320n may read data and/or status from slave devices 322a-322n, and may write data to memory or may configure the slave devices 322a-322n. Configuration may involve writing to one or more registers or other storage on the slave devices 322a-322n.

In the example illustrated in FIG. 3, a first master device 302 coupled to the RFFE bus 330 may control one or more bus slave devices 322a-322n and read data from, or write data to the slave devices 322a-322n. The first master device 302 may include a clock generator 304 for establishing a serial clock line (SCLK) frequency, a command sequencer 306 for establishing the command sequences sent to the slave devices 322a-322n, RFFE registers 308, a processing circuit and/or control logic 312, a transceiver 310 and an interface including at least one driver/receiver circuit 314 to couple the first master device 302 to the RFFE bus 330, e.g., via a serial data line (SDATA) 318 and driver 315 for driving an SCLK line 316. The processing circuit and/or control logic 312 may include a processor such as a state machine, sequencer, signal processor or general-purpose processor. The interface may be implemented using the state machine. Alternatively, the interface may be implemented in software on a suitable processor if included in the first master device 302. The transceiver 310 may include one or more receivers 310a, one or more transmitters 310c and certain common circuits 310b, including timing, logic and storage circuits and/or devices. In some instances, the transceiver 310 may include encoders and decoders, clock and data recovery circuits, and the like.

The RFFE standard specifies that the serial bus or interface includes a clock line and a bidirectional data line. Through the RFFE bus, an RFFE master device (e.g., 302 or one of master devices 320a-320n) may read from, and write to, registers in a plurality of RFFE slave devices 322a-322n so as to control the RF front end devices. The RFFE bus 330 is typically implemented as a serial bus in which data is converted from parallel to serial form by a transmitter, which transmits the encoded data as a serial bitstream. A receiver processes the received serial bitstream using a serial-to-parallel convertor to deserialize the data. The serial bus may include two or more wires, and a clock signal may be transmitted on one wire with serialized data being transmitted on one or more other wires. In some instances, data may be encoded in symbols, where each bit of a symbol controls the signaling state of a wire of the RFFE bus 330.

In an aspect, the RFFE master device 302 may generate commands that are sent to various slave devices 322a-322n. The read and write commands are organized in the RFFE standard into protocol messages that may each include an initial sequence start condition (SSC), a command frame that includes an identifier such as a unique slave identifier (USID), a data payload, and a final bus park cycle (BPC) to signal the end of the command. The protocol messages include register commands, extended register commands, and extended register long commands. The protocol messages may further include broadcast commands. The register, extended register, and extended register long commands (three types of commands) can all be either read or write commands. In an aspect, the command sequencer 306 may be configured to generate specific command sequences sent by the master devices 302 and 320a-320n, including the various broadcast commands.

The latency involved with transmitting any of the commands thus depends on the number of bits in its various frames as well as the clocking speed for the RFFE clock line. Under the RFFE protocol, each bit of a transmitted frame corresponds to a period of the clock since the transmission is single data rate (SDR), which corresponds to one bit per clock cycle. For example, an SDR results from transmitting a bit responsive to each rising edge (or, alternatively, to the falling edges) of the clock SCLK.

In a further aspect in accordance with the present disclosure, the RFFE master devices 302 or 320a-320n may be configured to set the SCLK frequency with the clock generation circuitry 304, which, in turn, may be under the control of the processor and control logic 312. In particular aspects, various different clock frequencies may be generated for the various versions of RFFE standards (e.g., Versions 1, 2, or 3), dependent on the slave device 322 for which the command sequences are intended. As will be discussed in further detail later, the clock generation circuitry 304 may be configured to allow the processor and control logic 312 to selectively set and change the frequency of the SCLK for different times or portions of the command sequence to enable slave devices of various operating frequencies coupled to a shared bus to be able to interpret the beginning portion of a command sequence.

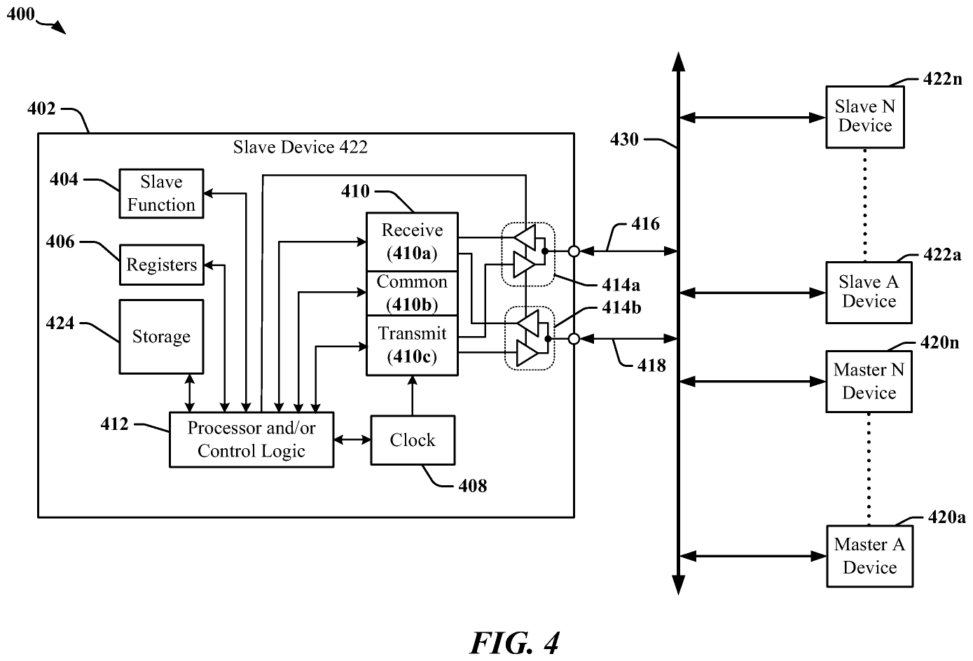

FIG. 4 is a block schematic diagram illustrating an example of a further architecture 400 for devices that may employ an RFFE bus 430 to connect bus master devices 420a-420n and slave devices 402 and 422a-422n. The RFFE bus 430 may be configured according to application needs, and access to multiple buses 430 may be provided to certain of the devices 420a-420n, 402, and 422a-422n. As discussed before, in operation one of the bus master devices 420a-420n may gain control of the bus and transmit an identifier for a slave device such as a unique slave identifier (USID) that is akin to a slave address, to identify one of the slave devices 402 and 422a-422n to engage in a communication transaction. Bus master devices 420a-420n may read data and/or status from slave devices 402 and 422a-422n, and may write data to memory or may configure the slave devices 402 and 422a-422n. Configuration of the slave devices may involve writing to one or more registers or other storage on the slave devices 402 and 422a-422n.

In the example illustrated in FIG. 4, a first slave device 402 coupled to the RFFE bus 430 may respond to one or more bus master devices 420a-420n, which may read data from, or write data to the first slave device 402. In one example, the first slave device 402 may include or control a power amplifier (See e.g., PA 215 in FIG. 2), and one or more bus master devices 420a-420n may configure a gain setting at the first slave device 402. The first slave device 402 may also include RFFE registers 406 and/or other storage devices 424, a processing circuit and/or control logic 412, a transceiver 410 and an interface including a number of line driver/receiver circuits 414a, 414b as needed to couple the first slave device 402 to the RFFE bus 430, e.g., via a serial clock line (SCLK) 416 and a serial data line (SDATA) 418. The processing circuit and/or control logic 412 may include a processor such as a state machine, sequencer, signal processor or general-purpose processor. The interface may be implemented using the state machine. Alternatively, the interface may be implemented in software on a suitable processor if included in the first slave device 402. The transceiver 410 may include one or more receivers 410a, one or more transmitters 410c and certain common circuits 410b, including timing, logic and storage circuits and/or devices. In some instances, the transceiver 410 may include encoders and decoders, clock and data recovery circuits, and the like. The slave device 402 also may include a clock 408, which is configured to communicate with the processor and control logic 412 to determine a transmit clock (TXCLK) signal that may be provided to the transmitter 410c, where the TXCLK signal can be used to determine data transmission rates.

To control the slave devices 402 and 422a-422n, a master device (e.g., one of master devices 420a-420n) either writes or reads to RFFE registers within the slave devices, e.g., the RFFE registers 406 within the first slave device 402. The RFFE registers 406 may be arranged according to an RFFE register address space that ranges from a zeroth (0) address to a 65535 address. In other words, each slave device might include up to 65,536 registers. To address such a number of registers, 16 register address bits for each of the slave devices 402 and 422a-422n are required. The master device may read from or write to the registers 406 in each slave device using one of the three types of commands discussed above (register command, extended register command, or extended register long command). For example, the register command addresses only the first 32 registers 406 in the address space for each of the slave devices 402 and 422a-422n. In this fashion, the register command requires only five register address bits. In contrast, the extended register command may initially access up to the first 256 registers in each of the slave devices 402 and 422a-422n. A corresponding 8-bit register address for the extended register command acts as a pointer in that the data payload for the extended register command may include up to 16 bytes. A corresponding read or write operation for an extended register command may thus extend across 16 registers starting from the register identified by the 8-bit register address. The extended register long command includes a 16-bit register address which may act as a pointer to any of the possible 65,536 registers in each slave device. The data payload for an extended register long command may include up to eight bytes so that the corresponding read or write operation for the extended register long command may extend across eight registers starting from the register identified by the 16-bit address. In an aspect of the disclosure, up to 15 slave devices may be coupled to one RFFE bus. If a front end includes more than 15 slave devices, additional RFFE busses may be provided.

As mentioned above, protocol messages may include broadcast commands, where register, extended register, and extended register long commands (three types of commands) can all be either read or write commands With regard to the three types of commands, the registers in each of the RFFE slave devices (e.g., registers 406) are organized into a 16-bit wide address space (0x0000-0xFFFF in hexadecimal). Each of the three types of commands includes a command frame that addresses a specific RFFE slave device as well as the register address. A command frame in the register command (register command frame) is directed to the registers in the first five bits of an address space (0x00-0x1F) such that only five register address bits are needed. The register command frame is followed by an 8-bit data payload frame. In contrast, an extended register command frame includes eight register address bits and may be followed by up to 16 bytes of data. Finally, an extended register long command frame includes a full 16-bit register address so it can uniquely identify any register in the addressed RFFE slave device. The extended register long command frame may be followed by up to eight bytes of data.

Each of the three types of RFFE commands—extended register, extended register long, and register—may be either a read or a write command. In general, each write command writes a full byte to each specified register. However, it may be the case that the RFFE master device does not need to change all eight bits in a RFFE slave device register. Furthermore, in many devices, more than one master or radio access technology (RAT) component may share control bit(s) in the same RFFE slave device register. To avoid contaminating the bits corresponding to the “other” source that writes to the same register, a “partial write” operation may be desired. In such a partial write operation, the RFFE master device must first perform a read operation on the selected slave device register using the appropriate one of the three command types. The RFFE master device then knows the current state of all the bits in the corresponding RFFE slave device register. The RFFE master device may then issue an RFFE write command using the appropriate one of the three command types in which the data payload for the corresponding slave device register has the bits it is changing while all the remaining bits stay in their current state as determined by the previous read operation. The need for a read operation prior to the partial write operation increases latency that may violate the latency requirements of certain Radio Access Technologies being implemented in the corresponding RF frontend.

In the systems of FIGS. 2, 3, and 4, it is noted that if any of the slave devices operate at different clock speeds from each other, such as 52 MHz and 78 MHz speeds, known solutions have included the provision of multiple RFFE buses operating at respective different frequencies where devices of like speed are connected to one bus and other devices of a different speed connected to another bus. Accordingly, the present methods and apparatus provide for a protocol in which RFFE devices having differing clock frequencies may share a common RFFE bus and yet correctly detect a command and process the command based on a sequence start condition (SSC) and USID.

### Shared Bus Protocol for Devices Having Different Clock Frequencies

According to aspects of the present disclosure, the disclosed methods and apparatus provide a protocol to enable a MIPI RFFE bus to be shared by MIPI RFFE slave devices with different clock speeds, e.g., 52 MHz devices and 78 MHz devices. In a particular aspect, for any MIPI RFFE command on the bus, a master device may be configured to send a start condition signal, such as a sequence start condition (SSC), and a device identifier, such as the unique slave ID (USID), portion of a command frame using a lowest supported clock frequency on the SCLK line. Accordingly, any legacy devices with lower clock capability (e.g., 52 MHz or below) as well as newer devices with higher clock capability (e.g., 76.8 MHz and above) will be able to correctly detect the command and process the command based on the SSC and USID, for example. Afterward, the master device can switch to a faster clock frequency for the later part of the command frame to ensure correct operation for higher frequency slave devices, or remain at the lower speed for lower frequency devices. In this system, a command sequence accompanied with the faster clock after the initial SSC and USID can only be processed by the faster device having the matching USID and will be discarded and ignored safely by those slower devices having an unmatched USID without any need to modify the operation of known slave devices.

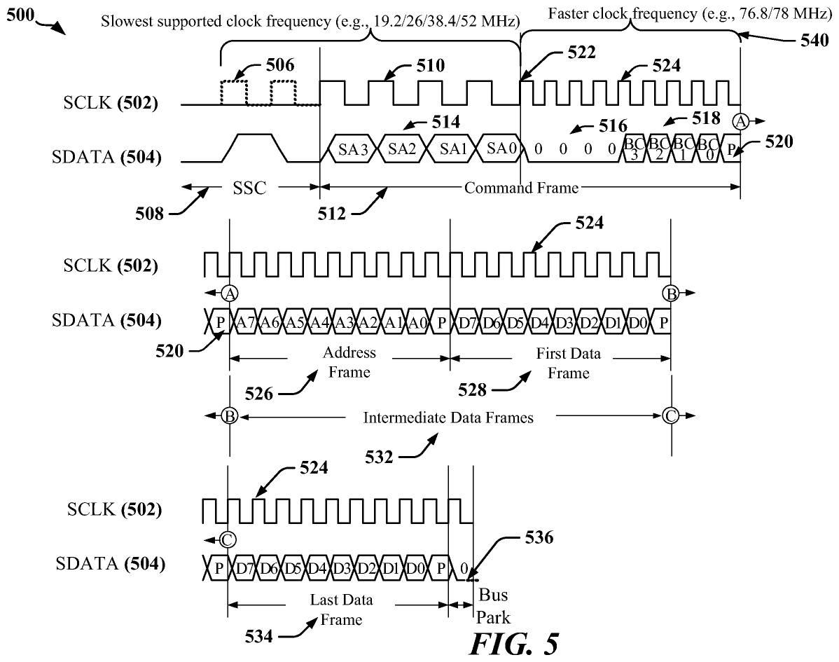

FIG. 5 is a timing diagram 500 illustrating certain aspects of the timing relationship between signals on the serial data (SDATA) and serial clock (SCLK) wires in an RFFE interface or bus. In this example, the signals illustrated are transmitted by a master device, such as master device 302 in FIG. 3. As illustrated in FIG. 5, the top portion of each timing diagram is of an SCLK line 502 and bottom portion of each timing diagram is of an SDATA line 504. Prior to the issuance of a command on the SDATA line 504, there is no actual driven clock signal on the SCLK line 502, and the SCLK line is pulled down where the SCLK is effectively withheld or quiescent. However, the slower clock frequency may be realize internally within a master device, wherein a first clock frequency for the SCLK line 502 may be virtually initiated in the master device as shown by dashed clock signals 506, which are concurrent with a start condition signal 508 (e.g., an SSC) sent on the SDATA line 504. The first clock frequency may be a lowest or slowest clock frequency supported among the group of slave devices connected to the RFFE bus.

After the start condition signal 508 is sent on the bus, the master device will begin to drive the clock on SCLK line 502 at the first clock frequency as illustrated by clock signal 510. Concurrent with the initial first clock frequency clock signal 510, the master transmits an command frame 512, which includes a device identifier portion 514 or unique slave identifier (USID) 716 comprised of four symbols SA3 to SA0, read/write and symbol command type determination symbols 516, bus park cycles (i.e., BC 3-BC 0 as shown in FIG. 5) 518, which are set based on the type of command frame, and a parity bit 520. In the example of FIG. 5, it may be seen that if the command frame transmission is intended for a higher frequency slave device, the master device increases the frequency of SCLK line 502 starting after the device identifier portion 514 of the command frame 512, indicated at reference number 522. In this manner, all slave devices on RFFE bus may process the SSC 508 and identifier 514 with a clock operable at a lower or lowest supported frequency 510, and if the device is a high speed device, the clock frequency is then increased to a higher, second frequency 524 for proper processing and operation of the remainder of the command frame 512 (indicated by bracket 540), and then also continuing for subsequent address and data frames. Alternatively, if the slave device has lower frequency capabilities, the SCLK 502 signal would remain the same after time point 522 to allow the slower device to properly process the command frame and subsequent address and data frames. In a further aspect, the master device may be configured to set the SCLK frequency to a multiple number of frequencies, such as in the case of three or more types of slave devices having respective operating frequencies.

FIG. 5 further illustrates that, in the case of selection of a higher frequency clock signal (second frequency 524), a subsequent address frame having symbols A7-A0, and a number of data frames each having respective symbols D7-D0 (i.e., first data frame 528, a number of intermediate data frames 532, and a last data frame 534) will be processed using the higher second clock frequency 534, before the SDATA bus 504 is then returned to a park state as shown at 536, and the clock SCLK line 502 is also pulled to ground.

It is noted that a master device driving the SCLK and SDATA lines 502, 504 shown in FIG. 5 may be configured to always set the SCLK frequency to the lowest supported frequency among a plurality of slave devices coupled to an RFFE bus. Additionally, it is noted that because the processing or control circuitry of a master device (e.g., 312) and/or command sequencer 306 determines the command sequences to be sent on the bus, the processing circuitry or logic may simply be configured to switch to the higher SCLK frequency for those command sequences known to the processor a priori to be sent to higher frequency slave devices.

### Examples of Processing Circuits and Methods

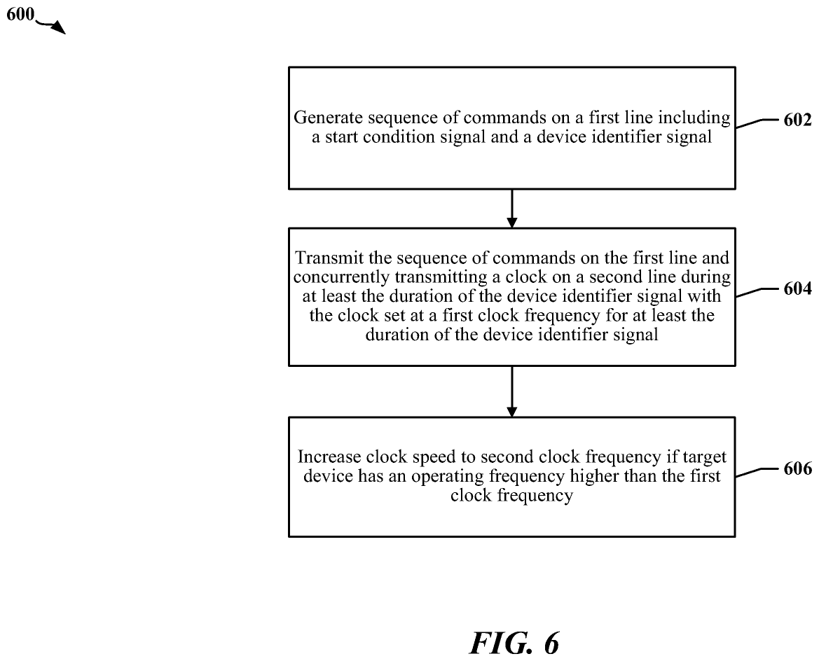

FIG. 6 is a flowchart illustrating certain aspects of the method of operation 600 of an apparatus for communication on a serial bus, such as master device 302 illustrated in FIG. 3 as one example. In particular, method 600 is a method for sharing a serial bus among a plurality of devices having differing operating frequencies that are coupled to the serial bus in accordance with aspects of the present disclosure.

The method 600 may include generating a sequence of commands on a first line of the serial bus, the sequence of commands including at least a start condition signal and a device identifier signal as shown in block 602. In an aspect, the device identifier signal is part of a command frame in the sequence of commands, such as a USID (e.g., USID 514). It is noted that in one example, the processes or functions of block 602 may be implemented by device 302 in FIG. 3 and, in particular, one or more of processor 312, transceiver 310, command sequencer 306, and interface 314, or equivalent circuitry or logic that may performs these functionalities. Method 600 further includes transmitting the sequence of commands on the first line of the serial bus and concurrently transmitting a clock signal on a second line of the serial bus during at least the duration of the device identifier signal as shown in block 604. The frequency of the clock signal is set at a first clock frequency for at least the duration of the device identifier signal, wherein the first clock frequency is a frequency that is supported among all of the plurality of devices coupled to the serial bus. In a further aspect, the first clock frequency may be selected to be the slowest or least clock frequency supported among the plurality of slave or peripheral devices. In an example, the processes or functions of block 604 may be performed by device 302 in FIG. 3 and, in particular, one or more of processor 312, transceiver 310, command sequencer 306, interface 314, clock generation circuitry 304, and interface 315 or equivalent circuitry or logic that may performs the functions of block 604.

In a further aspect, method 600 may also include switching the clock signal to at least a second clock frequency that is greater than the first clock frequency on the second line of the serial bus for a remainder of the command frame after the device identifier signal (e.g., time 540 in FIG. 5) when the sequence of commands is intended for a device supporting frequencies higher than the first clock frequency as shown at block 606. According to one aspect, the processes or functions of block 604 may be performed by device 302 in FIG. 3 and, in particular, one or more of processor 312, transceiver 310, command sequencer 306, interface 314, clock generation circuitry 304, and interface 315 or equivalent circuitry or logic that may performs the functions of block 606. In a further alternative, method 600 may include switching the clock signal to one of a plurality of second clock frequencies that are greater than the first clock frequency on the second line of the serial bus for the remainder of the command frame after the device identifier signal when the sequence of commands is intended for a device supporting frequencies higher than the first clock frequency. In this alternative, the master device (e.g., 302) would be configured to switch to the appropriate frequency for the slave device.

In further aspects, method 600 may include the clock signal on the second line of serial bus being withheld or not being driven during the issuance of the start condition signal and then being started by a master device upon issuance of the device identifier signal at the first clock frequency during the duration of the device identifier signal.

Of further note, method 600 may be specifically implemented in the context of a MIPI RFFE bus, although the methodology is not necessarily limited to such. For example, the methods disclosed herein may be applicable to other systems, particularly other two-line busses or interfaces having peripheral or slave devices connected thereto with different frequency capabilities. Further in the context of MIPI RFFE, the start condition signal in method 600 may be a sequence start condition (SSC) signal and the device identifier signal is a unique slave identifier (USID).

In yet another aspect, method 600 may include the first clock frequency being set on the second line of the serial bus at the start of all command frames issued by a master device coupled to the serial bus. In this manner, a master device configures the interface or bus system to ensure that all slave or peripheral devices, regardless of a device's frequency capability, will be able to properly decode the device identifier signal. Accordingly, method 600 provides that the transmission of the of device identifier signal concurrent with clock signal at the first frequency will be configured such that, when received by devices of the plurality of devices coupled to the serial bus that do not match the device identifier signal, the devices that do not match the device identifier may respond to the command sequence by discarding or safely ignoring the remainder of the command sequence or frame regardless of whether the frequency of the clock signal is increased or not.

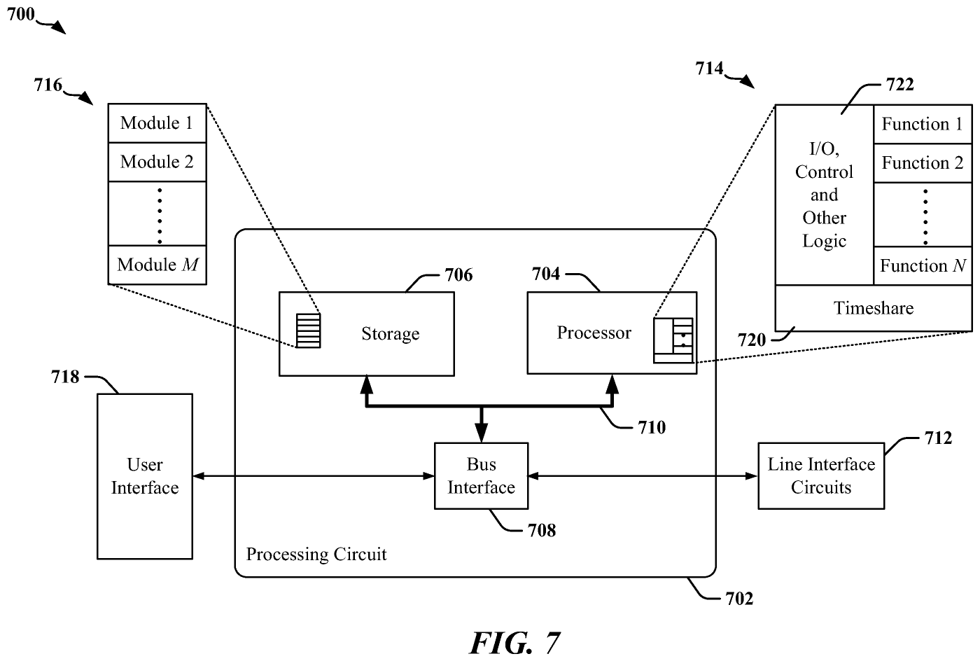

FIG. 7 is a diagram illustrating an example of a hardware implementation for an apparatus 700 employing a processing circuit 702 that may be configured to perform one or more functions disclosed herein. In accordance with various aspects of the disclosure, an element, or any portion of an element, or any combination of elements as disclosed herein may be implemented using the processing circuit 702. The processing circuit 702 may include one or more processors 704 that are controlled by some combination of hardware and software modules. Examples of processors 704 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 704 may include specialized processors that perform specific functions, and that may be configured, augmented or controlled by one of the software modules 716. The one or more processors 704 may be configured through a combination of software modules 716 loaded during initialization, and further configured by loading or unloading one or more software modules 716 during operation. In various examples, the processing circuit 702 may be implemented using a state machine, sequencer, signal processor and/or general-purpose processor, or a combination of such devices and circuits.

In the illustrated example, the processing circuit 702 may be implemented with a bus architecture, represented generally by the bus 710. The bus 710 may include any number of interconnecting buses and bridges depending on the specific application of the processing circuit 702 and the overall design constraints. The bus 710 links together various circuits including the one or more processors 704, and storage 706. Storage 706 may include memory devices and mass storage devices, and may be referred to herein as computer-readable media and/or processor-readable media. The bus 710 may also link various other circuits such as timing sources, timers, peripherals, voltage regulators, and power management circuits. A bus interface 708 may provide an interface between the bus 710 and one or more transceivers 712. A transceiver 712 may be provided for each networking technology supported by the processing circuit. In some instances, multiple networking technologies may share some or all of the circuitry or processing modules found in a transceiver 712. Each transceiver 712 provides a means for communicating with various other apparatus over a transmission medium. Depending upon the nature of the apparatus 700, a user interface 718 (e.g., keypad, display, speaker, microphone, joystick) may also be provided, and may be communicatively coupled to the bus 710 directly or through the bus interface 708.

A processor 704 may be responsible for managing the bus 710 and for general processing that may include the execution of software stored in a computer-readable medium that may include the storage 706. In this respect, the processing circuit 702, including the processor 704, may be used to implement any of the methods, functions and techniques disclosed herein. The storage 706 may be used for storing data that is manipulated by the processor 704 when executing software, and the software may be configured to implement any one of the methods disclosed herein.

One or more processors 704 in the processing circuit 702 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 706 or in an external computer-readable medium. The external computer-readable medium and/or storage 706 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 706 may also include, by way of example, a carrier wave, a transmission line, and any other suitable medium for transmitting software and/or instructions that may be accessed and read by a computer. Computer-readable medium and/or the storage 706 may reside in the processing circuit 702, in the processor 704, external to the processing circuit 702, or be distributed across multiple entities including the processing circuit 702. The computer-readable medium and/or storage 706 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 706 may maintain software maintained and/or organized in loadable code segments, modules, applications, programs, etc., which may be referred to herein as software modules 716. Each of the software modules 716 may include instructions and data that, when installed or loaded on the processing circuit 702 and executed by the one or more processors 704, contribute to a run-time image 714 that controls the operation of the one or more processors 704. When executed, certain instructions may cause the processing circuit 702 to perform functions in accordance with certain methods, algorithms and processes described herein.

Some of the software modules 716 may be loaded during initialization of the processing circuit 702, and these software modules 716 may configure the processing circuit 702 to enable performance of the various functions disclosed herein. For example, some software modules 716 may configure internal devices and/or logic circuits 722 of the processor 704, and may manage access to external devices such as the transceiver 712, the bus interface 708, the user interface 718, timers, mathematical coprocessors, and so on. The software modules 716 may include a control program and/or an operating system that interacts with interrupt handlers and device drivers, and that controls access to various resources provided by the processing circuit 702. The resources may include memory, processing time, access to the transceiver 712, the user interface 718, and so on.

One or more processors 704 of the processing circuit 702 may be multifunctional, whereby some of the software modules 716 are loaded and configured to perform different functions or different instances of the same function. The one or more processors 704 may additionally be adapted to manage background tasks initiated in response to inputs from the user interface 718, the transceiver 712, and device drivers, for example. To support the performance of multiple functions, the one or more processors 704 may be configured to provide a multitasking environment, whereby each of a plurality of functions is implemented as a set of tasks serviced by the one or more processors 704 as needed or desired. In one example, the multitasking environment may be implemented using a timesharing program 720 that passes control of a processor 704 between different tasks, whereby each task returns control of the one or more processors 704 to the timesharing program 720 upon completion of any outstanding operations and/or in response to an input such as an interrupt. When a task has control of the one or more processors 704, the processing circuit is effectively specialized for the purposes addressed by the function associated with the controlling task. The timesharing program 720 may include an operating system, a main loop that transfers control on a round-robin basis, a function that allocates control of the one or more processors 704 in accordance with a prioritization of the functions, and/or an interrupt driven main loop that responds to external events by providing control of the one or more processors 704 to a handling function.

In an aspect within the context of the present disclosure, the processing circuit 702, as an example, may be implemented as or within a master device. Functionalities and circuitry for implementing aspects of the setting of the clock frequency to a lower supported clock frequency during the SSC and USID transmission, and subsequent clock frequency increase if a command sequence is sent to a higher frequency slave or peripheral device as disclosed herein may be implemented in conjunction with the processor 704 or under control of the processor 704.

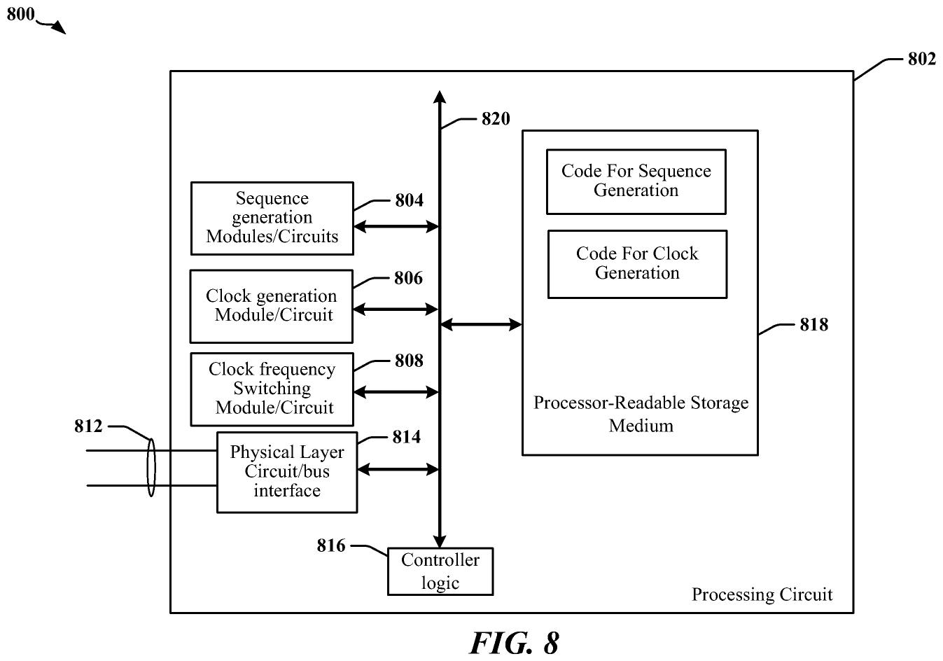

FIG. 8 is a diagram illustrating a simplified example of a hardware implementation for an apparatus 800 employing a processing circuit 802. The processing circuit typically has a controller logic or processor 816 that may include one or more microprocessors, microcontrollers, digital signal processors, sequencers and/or state machines. The processing circuit 802 may be implemented with a bus architecture, represented generally by the bus 820. The bus 820 may include any number of interconnecting buses and bridges depending on the specific application of the processing circuit 802 and the overall design constraints. The bus 820 links together various circuits including one or more processors and/or hardware modules, represented by the controller logic or processor 816, the modules or circuits 804, 806 and 808, and the computer-readable storage medium 818. The apparatus may be coupled to a multi-wire communication link using a physical layer circuit 814. The physical layer circuit 814 may operate the multi-wire communication link 812 to support communications in accordance with MIPI RFFE protocols. The bus 820 may also link various other circuits such as timing sources, peripherals, voltage regulators, and power management circuits, which are well known in the art, and therefore, will not be described any further.

The controller logic or processor 816 may be responsible for general processing, including the execution of software, code and/or instructions stored on the computer-readable storage medium 818. The computer-readable storage medium may include a non-transitory computer readable medium storing code or instruction for use by the processor 816. The software, when executed by the controller logic or processor 816, causes the processing circuit 802 to perform the various functions described above for any particular apparatus. The computer-readable storage medium may be used for storing data that is manipulated by the processor 816, when executing software. The processing circuit 802 further includes at least one of the modules 804, 806, and 808. The modules 804, 806, and 808 may include software modules running in the processor 816, resident/stored in the computer-readable storage medium 818, one or more hardware modules coupled to the processor 816, or some combination thereof. The modules 804, 806, and 808 may include microcontroller instructions, state machine configuration parameters, or some combination thereof.

In one configuration, the apparatus 800 includes the physical layer circuits 814 being line driver circuits including a first line driver coupled to a first wire of a multi-wire serial bus and a second line driver coupled to a second wire of the multi-wire serial bus 812, and line driver configuration modules and/or circuits 806. The apparatus 800 may include modules and/or circuits (not shown) that are configured to arbitrate between devices contending for access to the serial bus.

In one example, the apparatus 800 includes a controller (e.g., controller logic 816) configured for effectuating command sequence generation and clock generation for a master device coupled to a serial bus, such as multi-wire serial bus 812. The controller 816 may be configured to cause generation of a sequence of commands on a first line of the serial bus with the command including a start condition signal (e.g., SSC) and a device identifier signal (e.g., USID), wherein the device identifier signal is part of a command frame in the sequence of commands (See e.g., command frame 512 in FIG. 5). The controller 816 may then be further configured to cause transmission of the sequence of commands on the first line of the serial bus and concurrently cause generation and transmission of a clock signal on a second line of the serial bus during at least the duration of the device identifier signal, where the frequency of the clock signal is set at a first clock frequency for at least the duration of the device identifier signal, with the first clock frequency being a frequency that is supported among all of the plurality of devices, such as slave or peripheral devices, coupled to the serial bus. In order to accomplish these functions, the processor 816 may work in conjunction with or using sequence generation module or circuits 804 and clock generation module or circuits 806, or in conjunction with the computer-readable medium 818 including code or instructions for causing the processor 816 to perform one of more of these functions.

The controller 816 may be further configured to switch the clock signal on the second line of the serial bus to at least a second clock frequency that is greater than the first clock frequency for a remainder of the command frame after the device identifier signal is transmitted when the sequence of commands is intended for a device supporting frequencies higher than the first clock frequency. Alternatively, the controller 816 may keep the clock signal frequency set at the first frequency in the case where the intended device operates at the first frequency. In order to accomplish these functions, the processor 816 may work in conjunction with or using sequence generation module or circuits 804, clock generation module or circuits 806, and a clock frequency switching module or circuits 808, or in conjunction with the computer-readable medium 818 including code or instructions for causing the processor 816 to perform one of more of these functions.

In a further example, the processing circuit 802 may be contained within a MIPI Radio Frequency Front End (RFFE) device coupled to the serial bus 812, and the serial bus 812 may be a MIPI RFFE bus.

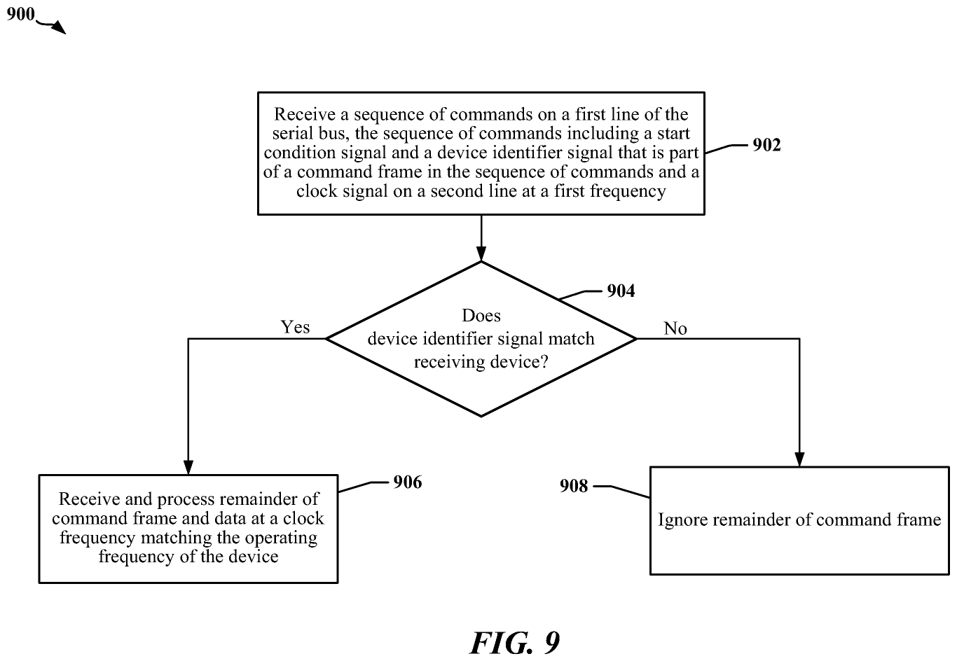

FIG. 9 is a flowchart illustrating another method 900 for receiving and processing command sequences in accordance with particular aspects of the present disclosure. Method 900 may be implemented in a slave or peripheral device coupled to a serial bus that include a plurality of devices coupled thereto, where at least two of the devices are operable at different frequencies. In one example, the slave device 422 in FIG. 4 may implement the processes or functions of method 900.

At a block 902, the device may receive a sequence of commands on a first line of the serial bus (e.g., an SDATA line) from a master device, where the sequence of commands include a start condition signal (e.g., SSC) and a device identifier signal. The device identifier signal is part of a command frame in the sequence of commands, such as command frame 512 illustrated in FIG. 5. The device also receives a clock signal on a second line (e.g., an SCLK line) at a first frequency, which is the lowest common supported frequency among the slave devices connected to and sharing the serial bus, in one example.

After receipt of the start condition signal, the slave devices coupled to the serial bus are alerted that the master device will be taking control of the bus and be transmitting a command frame including the device identifier signal. In method 900, the slave device may then receive and process the device identifier signal and make a determination whether the device identifier signal matches the particular receiving slave device at first lower frequency as shown in decision block 904. If the frequency matches, the slave device may then process the remainder of the command frame and the subsequent address information and data frames transmitted by the master device at the particular operating clock feature particular to the slave device as shown in block 906. The clock frequency may be increased by the master device or remain the same dependent on the particular operating frequency of the slave device. Alternatively, if the device identifier does not match as determined at block 904, then the slave device may safely ignore the remainder of the command frame and subsequent address and data frame transmissions as shown at block 906.

In a further aspect, the device implementing in method 900 is a MIPI Radio Frequency Front End (RFFE) device coupled to the serial bus, and the serial bus may be a MIPI RFFE bus.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

As will be appreciated by those skilled in the art, the present disclosure provides a compatible protocol for command sequences to provide a MIPI RFFE bus shared with MIPI RFFE slave devices having different clock speeds. Thus, for any MIPI RFFE command on the bus, the sequence start condition (SSC) and the unique slave ID (USID) part of the command Frame will utilize a lower or lowest clock frequency, enabling legacy devices with lower clock frequency capability to correctly detect the command sequence and process the commands based on the SSC and USID, for example, transmitted concurrently with the slower clock frequency, and newer devices with higher clock frequency (e.g., 78 MHz) capability can also correctly detect the command and process the command based on the SSC and USID. While use of the slower clock frequency does impose a time cost verses full higher frequency command sequences, because the slower clock is only used for the SSC and USID duration, at a minimum, the time cost is mitigated. Furthermore, the present methods and apparatus afford simple implementation on the master side and is transparent on the slave side, requiring no changes to slave devices.

The above description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.” Moreover, the term “or” is intended to mean an inclusive “or” rather than an exclusive “or.” That is, unless specified otherwise, or clear from the context, the phrase “X employs A or B” is intended to mean any of the natural inclusive permutations, such as the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A method for sharing a serial bus among a plurality of devices having differing operating frequencies that are coupled to the serial bus, the method comprising:
generating a sequence of commands on a first line of the serial bus, the sequence of commands including at least a start condition signal and a device identifier signal, wherein the device identifier signal is part of a command frame in the sequence of commands; and
transmitting the sequence of commands on the first line of the serial bus and concurrently transmitting a clock signal on a second line of the serial bus during at least a duration of the device identifier signal, wherein a frequency of the clock signal is set at a first clock frequency for at least the duration of the device identifier signal, wherein the first clock frequency is a frequency that is supported among all of the plurality of devices coupled to the serial bus.

2. The method of claim 1, further comprising:
switching the clock signal to at least a second clock frequency that is greater than the first clock frequency on the second line of the serial bus for a remainder of the command frame after the device identifier signal when the sequence of commands is intended for a device supporting frequencies higher than the first clock frequency.

3. The method of claim 1, further comprising:
switching the clock signal to one of a plurality of second clock frequencies that are greater than the first clock frequency on the second line of the serial bus for a remainder of the command frame after the device identifier signal when the sequence of commands is intended for a device supporting frequencies higher than the first clock frequency.

4. The method of claim 1, wherein the clock signal on the second line of the serial bus is not driven during issuance of the start condition signal and is started being driven by a master device upon issuance of the device identifier signal at the first clock frequency during the duration of the device identifier signal.

5. The method of claim 1, wherein the serial bus is a MIPI radio frequency front end (RFFE) bus.

6. The method of claim 5, wherein the start condition signal is a sequence start condition (SSC) signal and the device identifier signal is a unique slave identifier (USID).

7. The method of claim 1, wherein the first clock frequency is set on the second line of the serial bus at start of all command frames issued by a master device coupled to the serial bus.

8. The method of claim 1, wherein the first clock frequency is a slowest clock frequency supported among the plurality of devices coupled to the serial bus.

9. The method of claim 1, wherein transmission of the of device identifier signal concurrent with the clock signal at the first frequency is configured such that, when received by devices of the plurality of devices coupled to the serial bus that do not match the device identifier signal, the devices that do not match the device identifier signal may respond to the sequence of commands by ignoring a remainder of the command frame regardless of whether the frequency of the clock signal is increased or not.

10. An apparatus, comprising:
a bus interface configured to couple the apparatus to a serial bus having a first line configured to carry data and command signals and a second line configured to carry a clock signal; and
at least one processing circuitry, the processing circuitry configured to:
generate a sequence of commands on the first line of the serial bus, the sequence of commands including at least a start condition signal and a device identifier signal, wherein the device identifier signal is part of a command frame in the sequence of commands; and
transmit the sequence of commands on the first line of the serial bus and concurrently transmit a clock signal on the second line of the serial bus during at least a duration of the device identifier signal, wherein a frequency of the clock signal is set by the at least one processing circuitry at a first clock frequency for at least the duration of the device identifier signal, wherein the first clock frequency is a frequency that is supported among all of a plurality of devices coupled to the serial bus where at least two of the plurality of devices have different operating frequencies.

11. The apparatus of claim 10, the at least one processing circuitry further configured to switch the clock signal to at least a second clock frequency that is greater than the first clock frequency on the second line of the serial bus for a remainder of the command frame after the device identifier signal when the sequence of commands is intended for a device of the plurality of devices supporting frequencies higher than the first clock frequency.

12. The apparatus of claim 10, the at least one processing circuitry further configured to switch the clock signal to one of a plurality of second clock frequencies that are greater than the first clock frequency on the second line of the serial bus for a remainder of the command frame after the device identifier signal when the sequence of commands is intended for a device of the plurality of devices supporting frequencies higher than the first clock frequency.

13. The apparatus of claim 10, wherein the at least one processing circuitry is further configured to withhold driving of the clock signal on the second line of the serial bus during issuance of the start condition signal and then drive the clock signal upon issuance of the device identifier signal at the first clock frequency during the duration of the device identifier signal.

14. The apparatus of claim 10, wherein the serial bus is a MIPI radio frequency front end (RFFE) bus.

15. The apparatus of claim 14, wherein the start condition signal is a sequence start condition (SSC) signal and the device identifier signal is a unique slave identifier (USID).

16. The apparatus of claim 10, wherein the first clock frequency is set on the second line of the serial bus at start of all command frames issued by the apparatus.

17. The apparatus of claim 10, wherein the first clock frequency is a slowest clock frequency supported among the plurality of devices coupled to the serial bus.

18. The apparatus of claim 10, wherein transmission of the of device identifier signal concurrent with the clock signal at the first frequency is configured such that, when received by devices of the plurality of devices coupled to the serial bus that do not match the device identifier signal, the devices that do not match the device identifier signal may respond to the sequence of commands by ignoring a remainder of the control frame regardless of whether the frequency of the clock signal is increased or not.

19. An apparatus coupled to a serial bus shared among a plurality of devices having differing operating frequencies coupled to the serial bus, the apparatus comprising:
means for generating a sequence of commands on a first line of the serial bus, the sequence of commands including at least a start condition signal and a device identifier signal, wherein the device identifier signal is part of a command frame in the sequence of commands; and
means for transmitting the sequence of commands on the first line of the serial bus and concurrently transmitting a clock signal on a second line of the serial bus during at least a duration of the device identifier signal, wherein a frequency of the clock signal is set at a first clock frequency for at least the duration of the device identifier signal, wherein the first clock frequency is a frequency that is supported among all of the plurality of devices coupled to the serial bus.

20. The apparatus of claim 19, further comprising:
means for switching the clock signal to at least a second clock frequency that is greater than the first clock frequency on the second line of the serial bus for a remainder of the command frame after the device identifier signal when the sequence of commands is intended for a device supporting frequencies higher than the first clock frequency.

21. The apparatus of claim 19, further comprising:
means for switching the clock signal to one of a plurality of second clock frequencies that are greater than the first clock frequency on the second line of the serial bus for a remainder of the command frame after the device identifier signal when the sequence of commands is intended for a device supporting frequencies higher than the first clock frequency.

22. The apparatus of claim 19, wherein the clock signal on the second line of the serial bus is not driven during issuance of the start condition signal and is started being driven by a master device upon issuance of the device identifier signal at the first clock frequency during the duration of the device identifier signal.

23. The apparatus of claim 19, wherein the serial bus is a MIPI radio frequency front end (RFFE) bus where the start condition signal is a sequence start condition (SSC) signal and the device identifier signal is a unique slave identifier (USID).

24. The apparatus of claim 19, wherein the first clock frequency is set on the second line of the serial bus at start of all command frames issued by a master device coupled to the serial bus.

25. The apparatus of claim 19, wherein the first clock frequency is a slowest clock frequency supported among the plurality of devices coupled to the serial bus.

26. The apparatus of claim 19, wherein transmission of the of device identifier signal concurrent with the clock signal at the first frequency is configured such that, when received by devices of the plurality of devices coupled to the serial bus that do not match the device identifier signal, the devices that do not match the device identifier signal may respond to the sequence of commands by ignoring a remainder of the control frame regardless of whether the frequency of the clock signal is increased or not.

27. A non-transitory computer-readable medium storing computer-executable code, comprising code for causing a computer to:
generate a sequence of commands on a first line of a serial bus, the sequence of commands including at least a start condition signal and a device identifier signal, wherein the device identifier signal is part of a command frame in the sequence of commands; and
transmit the sequence of commands on the first line of the serial bus coupled to a plurality of devices having at least two different operating frequencies, and concurrently transmit a clock signal on a second line of the serial bus during at least a duration of the device identifier signal, wherein a frequency of the clock signal is set at a first clock frequency for at least the duration of the device identifier signal, wherein the first clock frequency is a frequency that is supported among all of the plurality of devices coupled to the serial bus.

28. The non-transitory computer-readable medium of claim 27, further comprising code for causing the computer to:
switch the clock signal to at least a second clock frequency that is greater than the first clock frequency on the second line of the serial bus for a remainder of the command frame after the device identifier signal when the sequence of commands is intended for a device supporting frequencies higher than the first clock frequency.

29. The non-transitory computer-readable medium of claim 27, further comprising code for causing the computer to:
switch the clock signal to one of a plurality of second clock frequencies that are greater than the first clock frequency on the second line of the serial bus for a remainder of the command frame after the device identifier signal when the sequence of commands is intended for a device supporting frequencies higher than the first clock frequency.

30. The non-transitory computer-readable medium of claim 27, further comprising code for causing the computer to:
withhold driving of the clock signal on the second line of the serial bus during issuance of the start condition signal; and
driving the clock signal upon issuance of the device identifier signal at the first clock frequency during the duration of the device identifier signal.
